(19) United States
(12) Patent Application Publication
(10) Pub. No.: US 2026/0055959 A1
(43) Pub. Date: Feb. 26, 2026

(54) CO2 PURIFICATION UNIT WITH HIGH PRESSURE FEED

(71) Applicant: L'Air Liquide, Societe Anonyme pour l'Etude et l’Exploitation des Procedes Georges Claude, Paris (FR)

(72) Inventors: Antoine SONNENDRUCKER, Champigny-Sur-Marne (FR); Elia CORDIER, Houston, TX (US); Mathieu LECLERC, Champigny-Sur-Marne (FR); Martin RAVENTOS, Champigny-Sur-Marne (FR)

(21) Appl. No.: 19/305,443

(22) Filed: Aug. 20, 2025

Related U.S. Application Data
(60) Provisional application No. 63/685,380, filed on Aug. 21, 2024.

(51) Int. Cl. F25J 3/06; B01D 53/22; B01D 53/26

(52) U.S. Cl. CPC F25J 3/067; B01D 53/229; B01D 53/265; B01D 2256/22; B01D 2257/404; B01D 2257/80

(57) ABSTRACT

A process to separate cryogenically a pressurized wet rich CO2 stream with at least 60% CO2 mol % and at least one other light component, including at least the following steps. Separation of water condensates from feed gas Dehydration of feed gas in a dedicated vessel. Condensation of CO2 rich feed gas creating an enriched CO2 liquid and a depleted CO2 gaseous stream. Vaporization of rich liquid CO2 stream. Separation of gaseous stream in membranes thereby creating an enriched CO2 stream and a depleted CO2 stream. Vent to the atmosphere depleted CO2 stream. Compression of enriched CO2 stream. Condensation of stream creating an enriched CO2 liquid and a depleted CO2 gaseous stream. Mixing liquid stream with liquid stream. Mixing gaseous streams.

### CROSS REFERENCE TO RELATED APPLICATIONS

This application claims the benefit of priority under 35 U.S.C. § 119 (a) and (b) to U.S. Provisional Patent Application No. 63/685,380, filed Aug. 21, 2024, the entire contents of which are incorporated herein by reference.

### BACKGROUND

A new generation of oxy-boosted combustion units, such as power plants, creates a wet high-pressure CO2 rich stream (>60% mol % CO2 dry basis). In order to purify and compress this feed gas, which can also contain impurities such as NOx or SOx, a cryogenic process may be used.

For such feed gas composition, the combination of a cryogenic section (partial condensation and stripping column) and membranes is frequently used to deliver a high purity liquid or gaseous CO2 product. However, most of the schemes are using a feed gas at atmospheric pressure and therefore leverage the initial feed gas compressor to recycle CO2 and enhance CO2 recovery in the process.

This innovation disclosure describes a process with a feed gas between 20 and 40b with >60% CO2 mol % at the inlet of the purification unit, leveraging this higher initial pressure compared to a typical scheme.

The main problem solved by this innovation is the management of CO2 recycles inside the process, especially the CO2 rich stream coming from the permeate of the membranes. This low-pressure stream is usually recycled back to the inlet of the feed gas compressor. In the presented scheme, there isn't any feed gas compressor as the initial pressure is >20b. Therefore, this stream is compressed in a small-scale compressor (screw compressor for example) and condensed again separately, allowing to reach a high CO2 recovery on the process with a low impact on CAPEX and OPEX.

Another issue faced was the gas used to regenerate the dryers at the inlet of the process. A typical scheme would use the permeate to regenerate them. However, in this configuration, permeate flow rate is not enough to be used as regeneration gas. Therefore, this scheme is using pure CO2 from the process at pressure above feed gas pressure, then this regeneration gas is recycled back to the inlet of the process.

Feed gas could also contain impurities such as NO, NO2 or SO2. If stringent specifications on CO2 products are imposed such as less than 1 ppm of NOx for example, these impurities have to be removed along the process. The presented scheme proposed to use a “reverted deNox” column scheme with a washing column with pure CO2 removing impurities before the final compression. At the bottom of this deNox column, the purge stream is a liquid CO2 stream rich in NO2. This stream is vaporized and recycled back to the inlet of the process. The reaction with water contained in feed gas will hydrolyse NO2 and NOx will be thus removed from the process through water condensates.

### SUMMARY

A process to separate cryogenically a pressurized wet rich CO2 stream with at least 60% CO2 mol % and at least one other light component, including at least the following steps. Separation of water condensates from feed gas Dehydration of feed gas in a dedicated vessel. Condensation of CO2 rich feed gas creating an enriched CO2 liquid and a depleted CO2 gaseous stream. Vaporization of rich liquid CO2 stream. Separation of gaseous stream in membranes creating an enriched CO2 stream and a depleted CO2 stream. Vent to the atmosphere depleted CO2 stream. Compression of enriched CO2 stream. Condensation of stream creating an enriched CO2 liquid and a depleted CO2 gaseous stream. Mixing liquid stream with liquid stream. Mixing gaseous streams.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation the method of CO2 purification, in accordance with one embodiment of the present invention.

FIG. 2 is a schematic representation the method of CO2 purification, in accordance with another embodiment of the present invention.

### ELEMENT NUMBERS

101=feed gas stream
102=phase separator
103=water condensate stream
104=vapor portion
105=dryer
106=dried feed gas stream
107=cryogenic section/main heat exchanger
108=pure CO2 stream
109=regeneration gas stream
110=cooled feed gas stream
111=first valve
112=flashed gas stream
113=stripping column
114=liquid CO2 stream
115=pump
116=(first) pressurized stream
117=(second) pressurized stream
118=(third) pressurized stream
119=(first) vaporized stream
120=(second) vaporized stream
121=(third) vaporized stream
122=combined stream
123=compressors
124=compressed combined stream
125=deNOx column
126=pure liquid CO2 stream
127=washed gas stream
128=liquid purge stream
129=pump
130=heat exchanger
131=vaporized CO2 stream
132=vapor stream
133=membrane unit
134=permeate stream
135=residue stream
136=heated residue stream
137=heated permeate stream
138=compressor
139=compressed stream
140=cooled enriched cCO2 liquid phase stream
141=phase separator
142=liquid portion
143=vapor portion
144=pressurized stream
145=product CO2 stream
201=phase separator
202=condensate stream
203=vapor stream
204=cooled feed gas stream
205=phase separator
206=vapor stream
207=condensate stream

### DESCRIPTION OF PREFERRED EMBODIMENTS

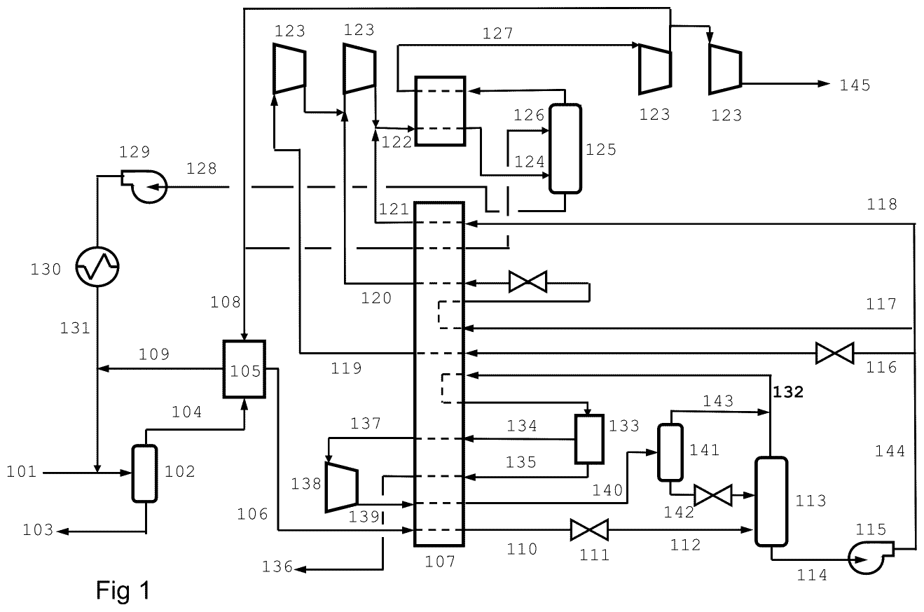

Turning to FIG. 1, feed gas stream 101 is a pressurized (20b-40b) CO2 rich stream (>60% mol % dry basis) containing water and other impurities such as NOx. Feed gas stream 101 is then introduced into phase separator 102.

After being separated from water condensate stream 103, vapor portion 104 of feed gas stream 101 introduced into dryer 105 and dried at high pressure and dried feed gas stream 106 is routed toward cryogenic section 107. Dryer 105 is regenerated at high temperature with pure CO2 stream 108 coming from CO2 compressor 123. After regeneration is complete, spent regeneration gas stream 109 is recycled and combined with feed gas stream 101. As dried feed gas stream 106 exits the outlet of main heat exchange 107, cooled feed gas stream 110 is close to CO2 triple point temperature.

Cooled feed gas stream 110 then flashed across first valve 111 and flashed gas stream 112 is introduced into stripping column 113. Stripping column 113 then removes light components. Liquid CO2 stream 114 enters pump 115, is pumped, thereby producing pressurized stream 144. Pressurized stream 144 is separated into three streams 116, 117, 118 with three different pressures, streams 116, 117, 118 are vaporized in main heat exchanger 107. This split helps to optimize main heat exchanger 107 and cold recovery.

Once vaporized, vapor streams 119, 120, 121 are mixed again into combined stream 122. Vapor streams 119, 120, 121 are compressed in compressors 123. After recompression, compressed combined stream 124 is introduced into deNox column 125. DeNox column washes combined compressed stream 124 with pure liquid CO2 stream 126 and allows the removal of the last traces of NO2 and heavy components. Washed gas stream 127 is routed again to the product compressor 123 in order to reach targeted product pressure and exits the system as product CO2 stream 145. Liquid purge stream 128 of deNox column 125 is a liquid CO2 stream with a high content of NO2. Liquid purge stream 128 is introduced into pump 129 and pumped to reach feed gas pressure, then vaporized against a heat source in heat exchanger 130, and vaporized CO2 stream 131 is recycled and combined with feed gas stream 101. Most of NO2 contained in this stream will be hydrolyzed in by water in feed gas and absorbed by water condensates.

Vapor stream 132 exiting at the head of stripping column 113 is reheated in main heat exchanger 107 before being routed to membrane unit 133. Membrane unit 133 separates vapor stream 132 into permeate stream 134 enriched in CO2 and depleted CO2 residue stream 135. Permeate stream 134 and residue stream 135 are sent back to main heat exchanger 107 to recover cold duty. Heated residue stream 136 is vented to the atmosphere. Heated permeate stream 137 is compressed in compressor 138 to ˜25b and compressed stream 139 sent back to main heat exchanger 107 to partially condensate CO2 still contained in this stream. Cooled enriched CO2 liquid phase stream 140 is sent to phase separator 141, thereby producing liquid portion 142 and vapor portion 143. Liquid portion 142 is sent to stripping column 113 to be further purified. Vapor portion 143 is mixed with vapor stream 132, and the combined stream is sent to membrane unit 133. This recycling of permeate in CO2 production helps enhance CO2 recovery in the process.

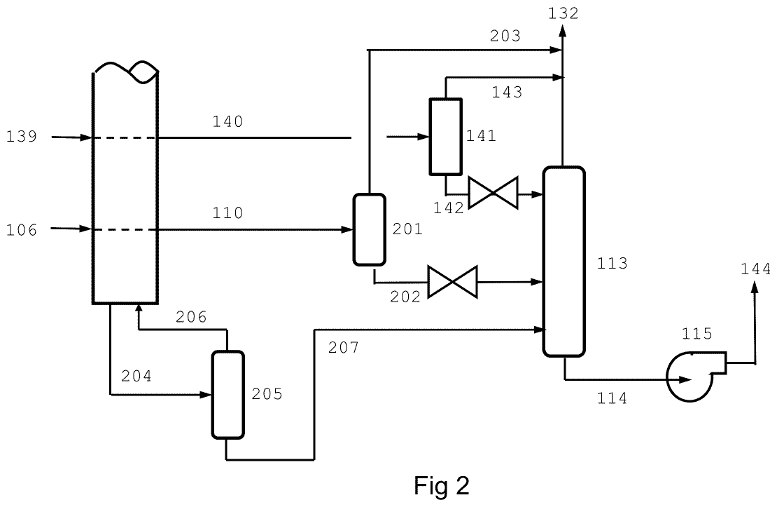

Turning to FIG. 2, an alternative from the previous scheme. It shows a partial condensation at an intermediate temperature and one close to triple point. Both liquid streams generated and separated in two vessels are sent to stripping columns.

In this scheme, dried feed gas stream 106 is routed toward cryogenic section 107. However, as dried feed gas stream 106 exits the outlet of main heat exchanger 107 and the temperature is close to CO2 triple point temperature, in this scheme cooled feed gas stream 110 is introduced into phase separator 201. After being separated, condensate stream 202 is introduced into stripping column 113, and vapor stream 203 is mixed with vapor portion 143 and vapor stream 132, and the combined stream is sent to membrane unit 133.

Additionally, cooled feed gas stream 204 is removed from main heat exchanger 107 at an intermediate temperature above that of cooled feed gas stream 110. Cooled feed gas stream 204 is introduced into phase separator 205. After being separated, condensate stream 207 is introduced into stripping column 113, and vapor stream 206 is returned to main heat exchanger 107.

### Example

| | | Feed | CO2 | Vent | Conden- |
|---|---|---|---|---|---|
| Stream | | Gas | Production | Gas | sates |
| Molar Flow Dry | Nm3/h | 63214 | 59332 | 3700 | 122 |
| Pressure | bara | 35.5 | 140 | 15 | 35.5 |
| CO2 (Dry Basis) | mol % v | 94.9 | 100 | 12.7 | 1.9 |
| Argon (Dry | mol % v | 0.2 | 0 | 4.4 | 0 |
| Basis) | | | | | |
| Nitrogen (Dry | mol % v | 4.1 | 0 | 69.7 | 0 |
| Basis) | | | | | |
| Oxygen (Dry | mol % v | 0.8 | 0 | 13.2 | 0 |
| Basis) | | | | | |
| Water | mol % v | 0.2 | 0 | 0 | 98.1 |

What is claimed is:

1. A process to separate cryogenically a pressurized wet rich CO2 stream with at least 60% CO2 mol % and at least one other light component and comprising at least the following steps:
a. separating water condensates from a feed gas stream,
b. dehydrating the feed gas stream in a dedicated vessel,
c. condensing a CO2 rich feed gas stream creating an enriched CO2 liquid stream and a depleted CO2 gaseous stream,
d. vaporizing the enriched liquid CO2 liquid stream from step c,
e. separating the depleted CO2 gaseous stream from step c. in a membrane separator, thereby creating an enriched CO2 stream and a depleted CO2 stream,
f. venting to the atmosphere the depleted CO2 stream from step e,
g. compressing the enriched CO2 stream from step e, thereby producing a compressed CO2 stream,
h. condensing the compressed CO2 stream from step g. thereby creating an enriched CO2 liquid and a depleted CO2 gaseous stream,
i. mixing the enriched CO2 liquid stream from step h. with the enriched CO2 liquid stream from step c, and
j. mixing the depleted CO2 gaseous stream from step h with the depleted CO2 gaseous stream from step c.

2. The process of claim 1 wherein the purification of liquid from step 1c and 1h is performed in a distillation column.

3. The process of claim 2 wherein a denox column is used to vaporize streams from step 1d to remove heavy components from CO2.

4. The process of claim 3 further comprising recycling of a purge stream from denox column to the condensate separator at process inlet.
